(19) United States
(12) Patent Application Publication
(10) Pub. No.: US 2006/0127536 A1
(43) Pub. Date: Jun. 15, 2006

(54) Coated animal feed supplement

(76) Inventor: John C. Fallin, Stillwater, MN (US)

Correspondence Address: ARMSTRONG, KRATZ, QUINTOS, HANSON & BROOKS, LLP;Intellectual Property Law Offices, Suite 220, 502 Washington Avenue, Towson, MD, 21204, US

(21) Appl. No.: 11/342,897

(22) Filed: Jan. 30, 2006

Related U.S. Application Data
(62) Division of application No. 10/631,202, filed on Jul. 31, 2003.

(51) Int. Cl. A23L 1/00

(52) U.S. Cl. 426/99

(57) ABSTRACT

A granular animal feed supplement which is coated with fat to reduce reaction with moisture and with acids and bases. A process is disclosed for preparing the fat coated animal feed supplement.

### BACKGROUND OF THE INVENTION

1. Field of the Invention

The present application is directed toward a coated animal feed supplement and more specifically, to granular potassium carbonate having a protective coating.

2. Description of Related Art

Potassium carbonate is a material which is frequently used in livestock feed. It is hygroscopic and should be kept dry. If the material is in a bag, the bag has a plastic liner to act as a moisture barrier. In the presence of water, there is an interaction with potassium carbonate and heat is produced. A heat generating reaction occurs when potassium carbonate is in the presence of strongly acidic or strongly basic materials In order to reduce the interaction of water with anhydrous potassium carbonate, hydrated forms of potassium carbonate have been used. However, the hydrated forms of potassium carbonate still react with strongly acidic and strongly basic materials. The addition of water to potassium carbonate reduces the potassium content from 56% to 48% and consequently, reduces the amount of potassium available in the animal feed.

There is a need to provide the maximum amount of potassium possible for use in animal feed formulations.

### BRIEF SUMMARY OF THE INVENTION

One object of the present invention is provide an animal feed formulation in which potassium carbonate is shielded to reduce the reaction of water with the potassium carbonate.

Another object of the present invention is to provide an animal feed with the highest possible amount of available potassium.

In accordance with the teachings of the present invention, there is disclosed a coated granular animal feed supplement having a coating formed in the animal feed supplement. The feed supplement is shielded to reduce reaction with moisture and acids and bases.

In further accordance with the teachings of the present invention, there is disclosed a process of preparing a coated animal feed supplement. Hydrogenated fat heated to a liquid form is provided. The liquid hydrogenated animal fat is transferred to a container under pressure. Anhydrous potassium carbonate is placed in a mixer. The mixer is rotated. Liquid hydrogenated fat at approximately 20-80 pounds per square inch is applied to the anhydrous potassium carbonate in the mixer wherein the anhydrous potassium carbonate is coated with the hydrogenated fat. A coating of one to five percent by weight is prepared. The fat coated anhydrous potassium carbonate is tested at regular intervals. The coating of the anhydrous potassium carbonate with the fat is continued until the test results meet a predetermined value.

These and other objects of the present invention will become apparent from a reading of the following specification taken in conjunction with the enclosed drawings.

### BRIEF DESCRIPTION OF THE DRAWINGS

FIG. 1 is a perspective view of granules of anhydrous potassium carbonate.

FIG. 2 is a cross-section view showing a granule of potassium carbonate coated with the hydrogenated animal fat.

FIG. 3 is a diagram of the process of coating the potassium carbonate with hydrogenated animal fat.

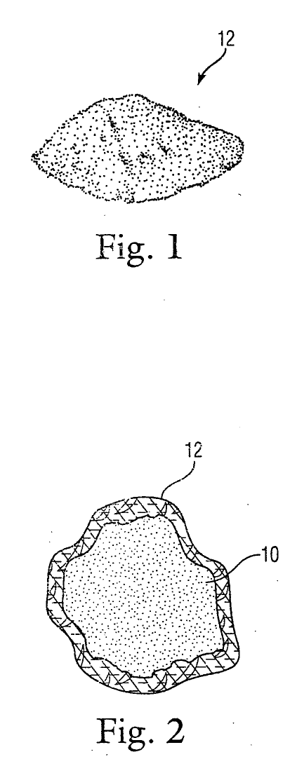

### DESCRIPTION OF THE PREFERRED EMBODIMENT

Potassium carbonate is very important as a feed supplement for animals and it is desirable to provide the maximum amount of potassium possible. Since the potassium carbonate is hygroscopic, the moisture collected reduces the available amount of potassium in a given weight of potassium carbonate. The use of anhydrous potassium carbonate provides the maximum available potassium but also presents problems because of affinity for water. The present invention addresses this problem by coating the anhydrous potassium carbonate with fat to prevent an interaction between water and the anhydrous potassium carbonate while maintaining a high level of available potassium.

A batch process for preparing the coated feed supplement is described herein although a continuous process may be used.

Hydrogenated animal fat 10 such as tallow is heated until the fat becomes liquid at about −180° F. It has been found that fat which is composed of triglycerides of mixed fatty acids of meat fat is satisfactory. The liquid fat is transferred to a container under pressure of approximately 20-80 pounds per square inch.

Anhydrous potassium carbonate granules 12 are placed in a mixer which is rotated at approximately three revolutions per minute. A Continental Rollo Mix Mark VI has been used satisfactorily although other mixers known to persons skilled in the art may be used. As the mixer rotates, the granules fall in a curtain-like manner.

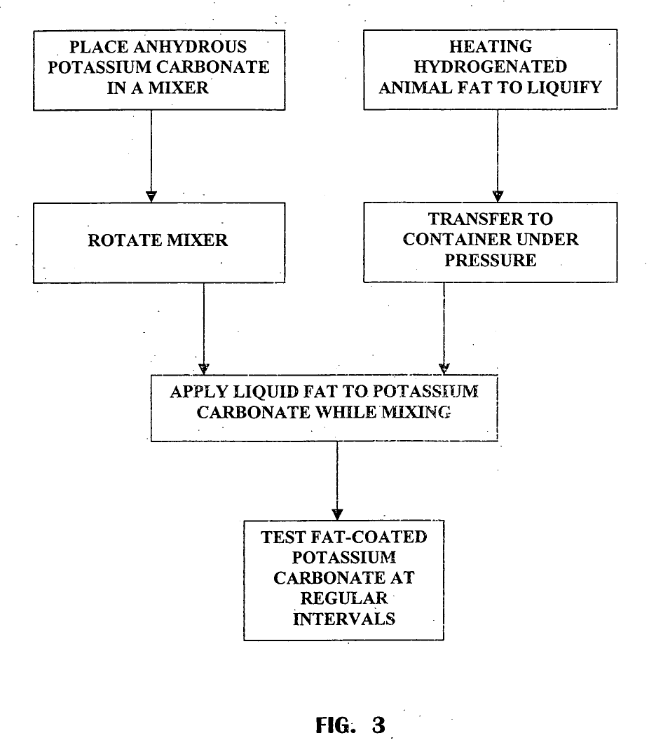

The heated fat 12 under pressure of 20-80 pounds per square inch is applied to the falling granules of anhydrous potassium carbonate until the granules are coated with approximately 1-5% by weight of the fat (FIG. 2).

The fat coated granules of anhydrous potassium carbonate are tested periodically. A sample of 60 g is placed in 60 ml of water and the temperature is monitored every 10 seconds. Over a two minute period, the temperature of the water should increase a maximum of 10-20° F. The increase in temperature is due to an interaction between the anhydrous potassium carbonate and the water. The application of the liquid hydrogenated animal fat is continued until the temperature increase is within the 10-20° F. range. When the test is conducted on non-coated granules of anhydrous potassium carbonate, a much greater temperature increase is produced with the water heating to approximately 112° F.

The final coated product has a minimum available potassium weight of 53% and a minimum potassium carbonate weight of 95%. The crude fat is 5% by weight (max.).

The fat coated anhydrous potassium carbonate has a particle distribution of US mesh −20 to +80. The bulk density is approximately 81 lb/cu ft.

The feed supplement is intimately mixed with the animal feed. The product provides more free potassium for absorption in the abomasum of the animal. The protective coating also helps prevent rumen microbial degradation of the elemental potassium. The protective coating further shields the potassium carbonate to reduce reaction even with strongly acidic or strongly basic materials which may be present.

Obviously, many modifications may be made without departing from the basic spirit of the present invention. Accordingly, it will be appreciated by those skilled in the art that within the scope of the appended claims, the invention may be practiced other than has been specifically described herein.

1-6. (canceled)

7. A process of preparing a coated granular animal feed supplement comprising the steps of:
providing hydrogenated animal fat heated to a liquid form,
transferring the liquid hydrogenated animal fat to a container under pressure,
placing anhydrous potassium carbonate in a mixer,
applying the liquid hydrogenated fat at approximately 20-80 pounds per square inch to the anhydrous potassium carbonate in the mixer, wherein the anhydrous potassium carbonate is coated with 1 to 5% by weight of the hydrogenated fat,
testing the fat coated anhydrous potassium carbonate at regular intervals,
continuing coating the anhydrous potassium carbonate with the fat until the test results meet a predetermined value.

8. The process of claim 7, wherein the hydrogenated animal fat is a liquid at approximately 180° C.

9. The process of claim 7, wherein the liquid hydrogenated animal fat is placed in a pressure tank.

10. The process of claim 7, wherein the test comprises placing 60 grams of the coated anhydrous potassium carbonate in 60 ml of water and checking the temperature every 10 seconds such that a maximum heat rise of 10-20° F. over a two minute period is the predetermined value.

11. The process of claim 7, wherein the mixer containing the anhydrous potassium carbonate is rotated approximately three revolutions per minute.

12. The process of claim 7, wherein when the mixer is rotated, the anhydrous potassium carbonate in the mixer falls in a curtain-like manner, the liquid hydrogenated fat being applied to the falling anhydrous potassium carbonate.

13. The coated animal feed supplement prepared by the process of claim 7.
